(19) United States
(12) Patent Application Publication
(10) Pub. No.: US 2009/0247281 A1
(43) Pub. Date: Oct. 1, 2009

(54) SYSTEM AND METHOD FOR INSTANT ON-LINE SELF SERVICE QUICK PICKS

(76) Inventor: George Voutes, Barrington, RI (US)

Correspondence Address: CESARI AND MCKENNA, LLP, 88 BLACK FALCON AVENUE, BOSTON, MA, 02210, US

(21) Appl. No.: 12/056,683

(22) Filed: Mar. 27, 2008

(51) Int. Cl. A63F 13/00

(52) U.S. Cl. 463/25

(57) ABSTRACT

An assembly, referred to as a side car, is disclosed that is retrofitted onto and integrated with an existing ITVM for providing on-line quick pick functionality. The added assembly, will include a controller that communicates with the ITVM and with a retailer computing system and then to a central host computer. Illustratively, the side car may interface via the retailer's router directly to the central host computer. The side car demonstrates simple pressing of one button may select a wager and randomly select a game and a number associated with that game, but other embodiments include multiple operations of the buttons. The buttons and displays may be programmable touch screens or LCD screens, but static labels and physical push buttons may be used. A scanner is provided that reads a player's card or fob with preloaded information that authorizes the player to wage on the games presented, and also wherein the favorite game and wager of the player may be executed on the machine. A player's hand held device may be enabled to communicate with the assembly.

### BACKGROUND OF THE INVENTION

1. Field of the Invention

The present invention relates to systems and methods related to lottery systems, and, more particularly, to instant on-line systems including quick pick capability.

2. Background Information

Lottery systems are well known throughout the United States. Generally these systems involve selecting a group of numbers that are printed on a ticket from an authorized vendor or agent of the lottery. The numbers are drawn and winners present their ticket(s) to a vendor and receive a prize, usually money. Another commonly found game includes vending “scratch” or instant tickets which involve exposing numbers that identify the game ticket as an immediate winner or loser.

There are many other variations of the above game themes, for example, quick picks (QPs) are available where the player selects a game and requests the vendor to randomly select a set of variables (usually numbers, but other devices may be found). The vendor prints out the ticket with the player's randomly selected numbers. The player checks against winning numbers when they are drawn. The player will usually cash a winning QP at the vendor.

Instant Ticket Vending Machines (ITVMs) are becoming ubiquitous. ITVMs successfully fulfill the customer's needs in the U.S. and in many parts of the world. ITVMs stand alone in an area where an authorized vendor controls who can approach and operate the machine. The ITVM accepts money (currency and coins) and dispenses a ticket. Typically the ticket, if a winner, is presented to an agent to collect winnings. However, a winning ticket may be brought to another vendor or mailed to a host data center for cashing.

FIG. 1 illustrates a prior art ITVM 2. The ITVM 2 includes a controller 4, that usually will have a microprocessor 6, a memory 8 (containing software), storage 10 (e.g, flash memory) and I/O (input output) devices 12. Typically, the I/O devices include displays 16, buttons 18, a cash handler 20, ticket dispensers 22, and communications 24.

The communications 24 may be by hard wire or wireless 26, but the ITVM only communicates with the local retailer 28. In these prior art systems, transactional information is not communicated between the ITVM and the retailer. Typically, the status of the ITVM (door open, ticket bin depleted, etc.), and totals of tickets sold may be communicated to the retailer. The retailer will often have the ability to communicate 30 with the Host 32, but that communications may be by using a separate system. The Host is the central entity having authority (usually from government bodies) to control and operate the entire lottery/gaming system.

FIG. 2 illustrates a front panel 40 of an exemplary prior art ITVM system. There is a top banner 42 announcing the availability of instant tickets, a cash handler and display 44 that indicates the amount of money available to wager, transparent bins 46, each containing a different instant ticket showing the cost of that ticket. The player selects and pushes a box 46, and, if there is enough money is in the machine, the ticket is dispensed falling to the slot 48 where the player may retrieve it. The money display is then decremented by the cost of the ticket.

Illustrative of the prior art state of the art, there are several U.S. patent applications have been published that disclose wireless lottery systems. One such application is Pub. No. US 2007/0093296A1 ('296), entitled “System and Method for Wireless Lottery”. Another is US2007/0213118 ('118), entitled “Method for Participating in Lottery Draw Over a Cellular Network and System Thereof.”

The '296 publication requires use of a mobile device (e.g., cell phone, iPhone, Blackberry, and the like). Details include limiting access and availability (to comply with the law) and the use of private wireless systems. A private network may include virtual private networks, as are known in the art.

The '118 publication discloses a cellular system for use in lottery drawings. A central computer is linked via a network to a drawing center and to mobile devices used by a lottery participant. Security systems are disclosed to protect the lottery and the customer.

As lottery type games evolve and expand, vendor free, secure, lottery systems and methods are needed to better satisfy the player or customer. In particular, prior art systems are often too complex, where the player, especially the casual player, may not participate because the machine appears too complex, or where selecting the game and wagering, etc. takes too long. The present invention provides for a simplicity that will allow fast operation and will not intimidate or otherwise drive players, especially novice players, away.

Moreover, placing the ITVM machines on-line confers benefits and advantages, that, when combined with simplicity, may provide better lottery-type systems.

### SUMMARY OF THE INVENTION

The present invention provides a stand alone system that may be an added assembly retro-fitted onto an installed ticket vending machine. When retrofitted, new hardware will be installed, but new software will also be overlaid onto the existing systems. Advantageously, the present invention will include instant quick picks (QPs), and will provide on-line features that allow a flexible wide array of gaming selections, payment channels, player information and account verification.

In another embodiment, the present invention may be a stand alone system wherein the functions of the retrofitted instant ticket vending machine, described above, are incorporated into a single, integrated machine.

Illustratively, the present invention provides for dedicated buttons that have one function. That function may be, illustratively, to generate a QP selection of a given dollar amount on a selected game, where the ticket with randomly selected numbers, game and wager is printed and dispensed to the player.

In another illustrative embodiment, one or more buttons may be “random”; that is, a button with a dollar amount label, that when pressed will randomly select a game (from ones displayed on the machine) and randomly select a number or set of numbers, that are then all printed out on a ticket. In yet other embodiments, pressing the “random” button may dispense one of the instant tickets.

In some embodiments, a scanner, e.g., a bar code scanner may be provided that will read and indicate to the player that the QP ticket scanned is a winner. The scanner can also include functionality which enables a player with an activated fob or play card, which includes a credit balance and the player's particular favorite numbers, for example, to scan/insert their fob or player card and receive a play ticket from the machine.

The player card or fob is a previously authorized and activated item that may contain indicators that the player is accepted by the entity sponsoring the lottery/game system. Typically a financial account with a balance stored at the central host system is accessed by the fob or player card. Protection systems and steps (known in the art) may be taken to ensure the fob and player card are used by the authorized player.

Cash may be first inserted into the machine and a display indicates a balance that may be wagered.

In other embodiments, the dedicated buttons may be implemented as physical push buttons that are labeled with the game and an amount. However, the buttons may be formed on a touch screen, and the labels (including game and wager amount) may be adjacent to or on the button. In yet other embodiments, the button labels may be programmed by the computer system in the machine. For example, the touch screen display may be controlled by a computer that may display virtually any game type and amount on a representation of the button. Moreover, the button displayed may be drawn on the screen in virtually any form desired by the programmer. Other programmable displays may include LCD-type screens mounted as part of or next to a physical button.

In embodiments, the host controller may control the games and wagers found on embodiments of the present invention.

In yet other embodiments, a QP for a game and a wager amount may be selected by the player by pushing or activating one, two or more buttons in sequence. For example, one button may select the game and a second button may select the amount. In yet other embodiments, when the game button is selected, the button may be pressed several times to increment an amount or a game type. Illustratively, pressing a $1 button twice will indicate a $2 wager, or a button indicating game type twice might increment to a second game. Again, pressing or depressing, as used herein, applies to “buttons” that may be on a touch screen, some other flat keypad-type, or be a physical button.

It will be appreciated by those skilled in the art that although the following Detailed Description will proceed with reference being made to illustrative embodiments, the drawings, and methods of use, the present invention is not intended to be limited to these embodiments and methods of use. Rather, the present invention is of broad scope and is intended to be defined as only set forth in the accompanying claims.

### BRIEF DESCRIPTION OF THE DRAWINGS

The invention description below refers to the accompanying drawings, of which:

FIG. 1 is a block diagram of a prior art system;

FIG. 2 is an illustrative front panel of the system of FIG. 1;

FIG. 3A is a pictorial drawing of a prior art ITVM with an illustrative inventive system attached;

FIGS. 3B, 3C, 3D, 3E, 3F and 3G illustrate other button layouts (but not exhaustive) of the attached inventive systems;

FIG. 4 is an illustrative block diagram schematic illustrating one embodiment of the invention;

FIG. 5 is a diagram of illustrative communications of an inventive system;

FIG. 6 is an illustration of a front panel of a system that integrates the side car and the ITVM into one assembly; and

FIG. 7 is a schematic block diagram of a computer system that may be used to advantage in the present invention.

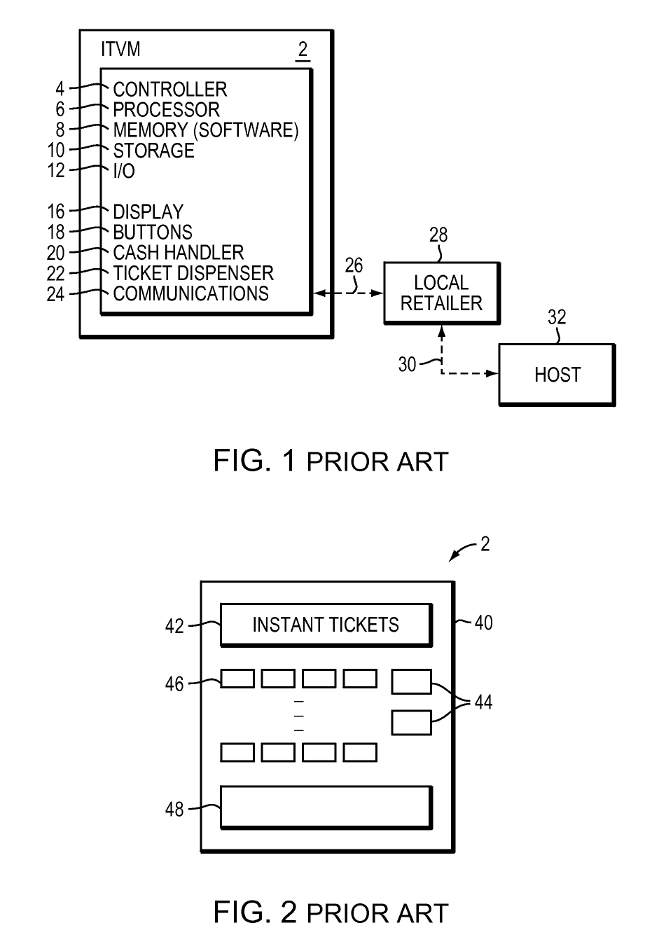

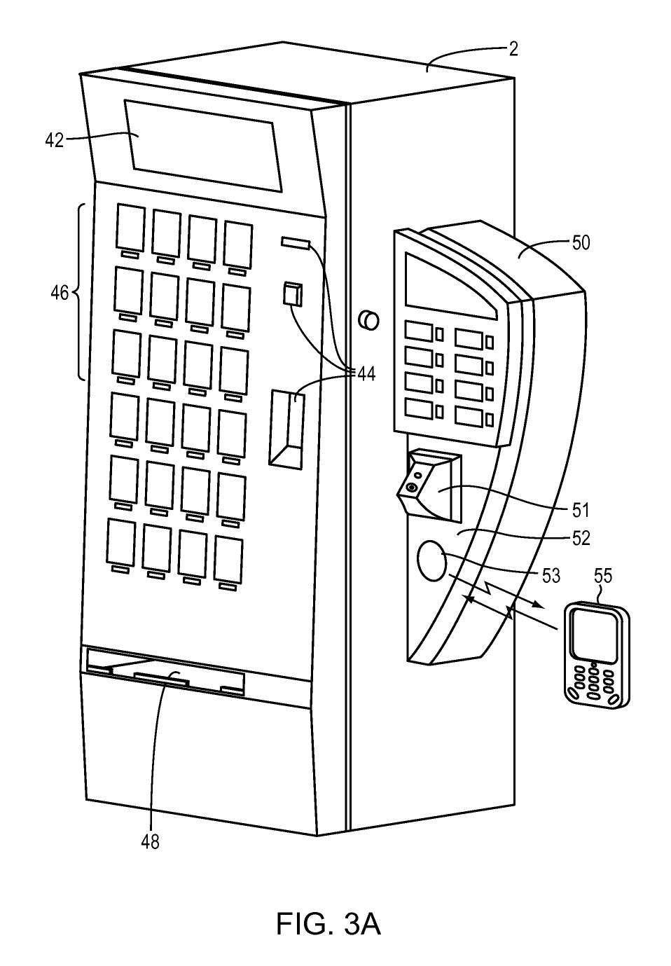

### DETAILED DESCRIPTION OF AN ILLUSTRATIVE EMBODIMENT

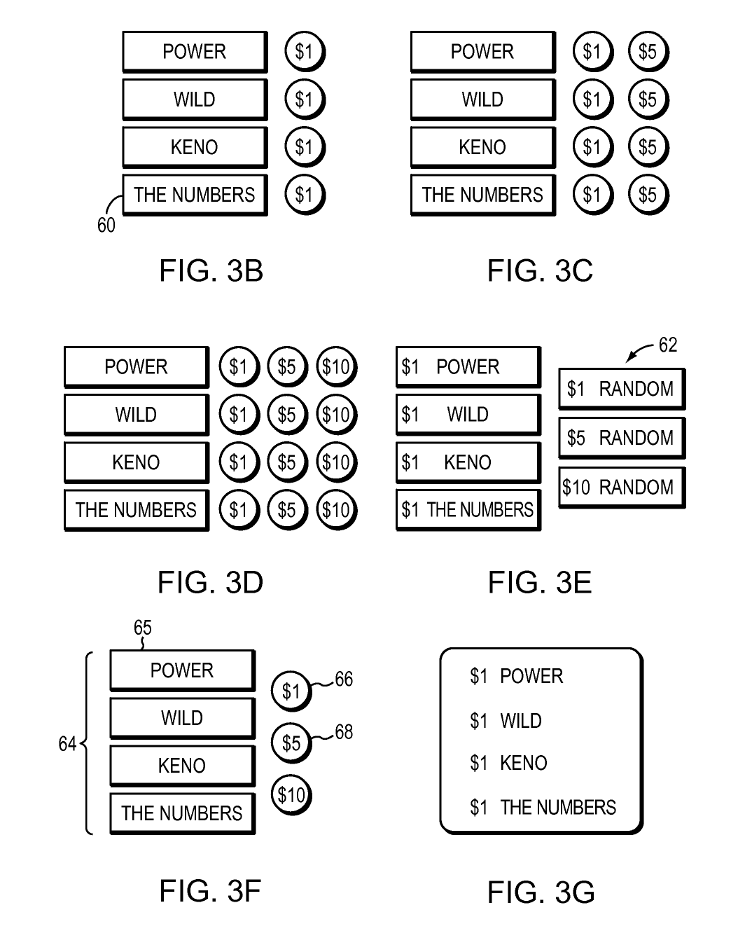

FIG. 3A illustrates one embodiment of the present invention. Here, the embodiment of the present invention 50 is shown with a prior art Instant Ticket Vending Machine (ITVM) 2. This system 50, more particularly, attaches to the side of the ITVM 2, and, is referred to herein as “side car.”

In this embodiment, the controller board 4 in the ITVM is replaced or refitted with upgraded software and a communications connection (e.g., USB port) to communicate with a controller in the side car. The side car will also have a communications channel to the retailer computer or, in some case, to the central host computer. In one example shown below, money is first inserted and displayed to the player on the ITVM 2. However, in another example, the player may also have an activated fob or player card that is read by a bar code, magnetic stripe or embedded-type reader/scanner 59. The player's account may be accessed and a credit amount may be displayed indicating the amount that the player may wager.

When game and wager amounts are selected, a ticket is printed 51 for the player. The money amount displayed is decreased accordingly. In some instances, the reader/scanner 59 will read a ticket and indicate a winner and an amount won.

In some embodiments, the fob or player card may indicate the player's game and wagers. In those embodiments, discussed below, where the host may program the games and wagers available on the machine, those games may be down loaded into the machine at the player's behest. For example, the host may display possible games where the player by depressing the button may select that game and betting amounts. In yet other embodiments, the player may use a hand held device 55 that can place telephone call to a receiver 53 in the side car 50. The games may be displayed on the cell phone and selection may be made but pressing keys on the cell phone. These operations may be accomplished using text messaging as known in the art. Pass words, encryption and the like may be used to ensure protection.

The following details some examples of the button layouts and operations for embodiments of the side car.

FIG. 3B illustrates a single column of four buttons, each arranged to wager one dollar on one game by depressing the indicated single button. There is a static label beside a physical button. However, in other embodiments, the label may be replaced with an LCD flat screen or some other display as known to those skilled in the art. In this example, pressing one button selects the game and an amount wagered. For example, depressing button 60 wagers one dollar on “THE NUMBERS” game. Another embodiment would allow the player to sequentially press the “THE NUMBERS” button to increase the size of the wager by one dollar each time the button is pressed. For example, as would be understood by those skilled in the art, a time out function may be included in the system operation where a player may press, for example, button 60 three times in succession and a three dollar wager will be made. Arrangements that limit the number of times a button may be pressed may be included. For example, a programmed time of say five seconds may be designed into the system. Here, if five seconds elapses, the selection is deemed completed and the ticket is printed and dispensed. Note, there is no separate game selection; the game and amount are selected by the single button.

FIG. 3C illustrates two columns of buttons. Again depressing one button selects the game and the amount wagered. Here a one or a five dollar wager may be selected on one of the four games illustrated. Again, there is no separate game selection needed.

FIG. 3D illustrates three columns of buttons. Again, pressing one button selects the game and the amount wagered. Here, one, five or ten dollar buttons may be selected.

FIG. 3E illustrates an alternative configuration to that of FIG. 3B. In FIG. 3B there is a label for the game that is next to the select button labeled $1. In FIG. 3E the label and the $1 are part of the button. Operation is the same as for FIG. 3B.

FIG. 3E includes another set of “random” buttons 62. For example, when the “$1 RANDOM” is pressed, one dollar will be placed on a randomly selected game from the games displayed on the machine, a random number or numbers is selected (appropriate for the game), and a ticket is printed out. In some embodiments, an instant ticket may be dispensed as one of the “randomly selected games.” FIG. 3E illustrates three possible selections for a “random” button, but fewer or more buttons may be used, and the wager amounts may be different.

FIG. 3F illustrates a simple two button selection process. Here, operation includes a column of four labeled buttons 64 each bearing the name of one game. The second column 66 of three buttons indicate wager amount—one, five and ten dollars. Illustrative operation would be, for example, for a player having ten dollars in his account, to select the power ball game by depressing the button 65 labeled POWER, and then select the five dollar button 68. The Power Ball ticket would be dispensed and the player's account is debited by the five dollars. The display would indicate an account balance of five dollars that the player may wager on a different game or games.

FIG. 3G illustrates a layout of buttons and displays as may be seen on a touch screen or an LCD-type/keypad flat panel. The same functionality may be implemented but with a different physical form. Please note, touch screens and LCD flat screens allow for the displays to be programmable, as discussed above. The present invention in alternative embodiments may employ such programmability advantageously.

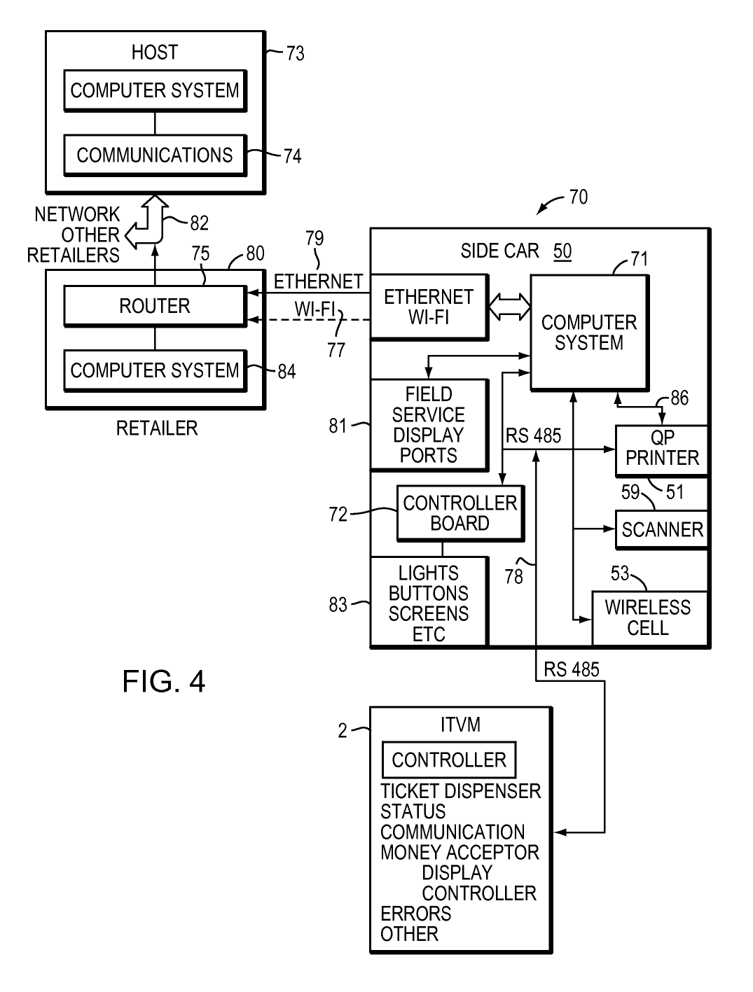

FIG. 4 is a representative diagram illustrating the electronics (hardware and software) 70 that may be found in the side car 50, and the interconnections to the ITVM 2, the retailer 80, and the host 73.

The host 73 is a central computing system of an authorized game entity running many on-line, instant, and other lottery-style games distributed over many retailers. There may be hundred of games, hundred of type of wagers, thousand of retailers and millions of players. The host 73 communicates with the retailer through a communications controller 74 via communications network 82. The network 82 may be private or it may use a public network like the Internet or a telephone system. Typically, the communications will be encrypted using (but not necessarily) one of the commercially available formats.

The host 73 is, typically, a large or distributed computer system designed to handle in an efficient manner millions of transactions emanating from many different retailers (or other possible types of sources)

Each retailer 80 includes a computing system 84 that operates the games at the retailer's place of business. The retailer's computing system 84 may be dispensing lottery tickets, and other variations of such games as discussed above. For example, horse racing games, car racing games, keno, combat-style and other types may be found in the art. Each retailer will often employ a router 75 and a wireless (Wi-Fi) 77 or hard wire (Ethernet) 79 communication link to the side car 50.

The side car also communicates with the ITVM 2, in this instance via an RS-485, a two wire connection; although other types of communication channels may be used, including wireless. In one embodiment, the ITVM 2 only dispenses instant tickets and only reports the local status of the ITVM. For example, if there is a problem, like an open door, or stuck ticket dispenser, that will be reported to the host via the side car 50. Also, the ITVM might report total amounts of instant tickets dispensed. Typically, status is reported with no transactional operations, but the other embodiments are not limited to status information only. Although not shown in detail, the ITVM 2 has a controller board with hardware and software to control the instant ticket dispensing, communicating status of the ITVM to the host via the side car 50, this reporting may include, errors and other problems, e.g., door open, ticket bin empty, and money that may be wagered, etc.

The side car block diagram item 70 includes a computer system board 71, typically a microcomputer that contains logic circuitry, memory containing software (programs), I/O, and perhaps storage, etc. The side car 50 includes programs that will handle the communications to the host 73 via the WI-FI connection 77 and/or an Ethernet cable 79. A separate controller board 72 communicates with the computer 71 via the RS-485 cable, and controls the lights and buttons 83 on the side car 50 illustrated in FIGS. 3B, 3C, 3D, 3E, 3F and 3G. Since a printer 51 is to be used by the side car 50 to print out tickets, confirmations, and other such information regarding QPs, the printer 51 may be configured to communicate with the computer 71 via the RS-485 cable 78, or it may be controlled wirelessly directly 86 from the computer 71. Provisions are made for set up and field service 81 where displays and entry ports for connecting, for example a service notebook computer, may be found. In addition, a scanner 59 and the wireless 53 connection (described below) are provided for the player.

Illustratively, the side car 50 adds on-line QP (quick pick) capability to the ITVM 2. As mentioned above, the ITVM 2 dispenses instant tickets, but the side car, illustratively, allows the player to select a game and an amount wagered by pushing a single button. For example, cash is loaded into via the ITVM 2 and displayed on the ITVM 2 for the player. The player then may push a QP button. The request is sent to the host, which returns an authorization for the side car to print out a ticket for the selected game and wager.

Advantageously, the side car communications with the host allows for downloading different functions for the displays and the buttons on the side car, see FIGS. 3A-3G. Here, the displays that hold the game labels and the wager amounts on the buttons are programmable. For example, as desired, the game types may be changed and the wager amounts may be changed, both to accommodate virtually any game and any amount.

In other embodiment, a player may have a funded account, or be an authorized player. Such a player may have an identity card or a fob that is read or scanned 59 whereupon the player scans his card and depresses a QP button. The player's fob or card may be of any of the known technologies, e.g., a magnetic card reader, an embedded card reader, and RFID fob, or virtually any other identification mechanism. In this case, the host will have the necessary particulars to authorize the player and the amount of the wagers and to hold and update the accounts for players. The host will store the winning numbers and authorize payment.

The wireless communication 53 may be constructed for a cell phone or other hand held device. A corresponding cell-type device may be resident in the side car 50 that responds when called. The interaction between the player's device and the side car 50 may use pass word, encryption and other such techniques to ensure the player is the person authorized by the host.

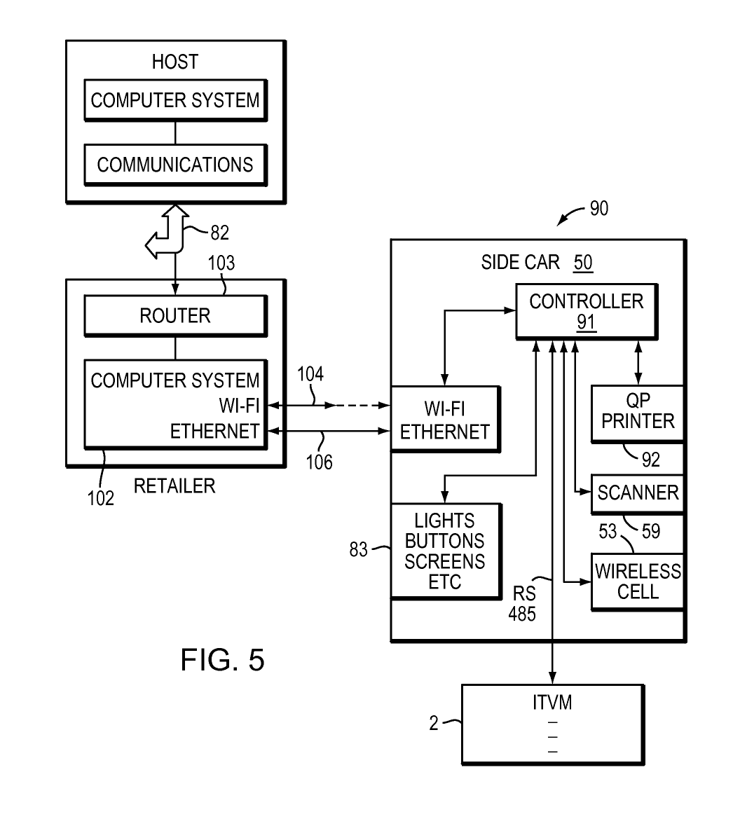

FIG. 5 illustrates another embodiment of the present invention where the ITVM 2 and the side car hardware and software 90, found in the side car 50 performs similar functions as the embodiment of the FIG. 4. In FIG. 4, the computer card 71 in the side car carries out the most complex functions, but in the configuration in FIG. 5, the controller board 91 carries out only relatively simple tasks of controlling the printer 92, the displays 83, and responding to the buttons 83 pressed on the side car only. The controller board 91 also acts as a conduit for communication from the ITVM 88 to the retailer computer system 102 where status reporting from the ITVM flows through the side car, and where money accepting and amounts are displayed and incremented or decremented as needed. The scanner 59 and the wireless 53 are as discussed for FIG. 4.

The retailer computer system 102 may be of a common lottery type, but since the side car 90 and the ITVM 88 both will communicate with the host via the retailer's computer system, the software and possibly hardware in the retailer's computer system will be refitted to accommodate the side car/ITVM. In FIG. 5, the controller board 91 communicates with the retailer's computer via Wi-Fi 104 or Ethernet 106. The retailer's computer communicates with the host via a router 103 at the retailer's computer system via the network 82. The information exchanged between the host and the ITVM is sub-stantially the same as that in FIG. 4. One exception is that in FIG. 4, there may be another communications connection between the ITVM and the host that bypasses the side car in FIG. 4.

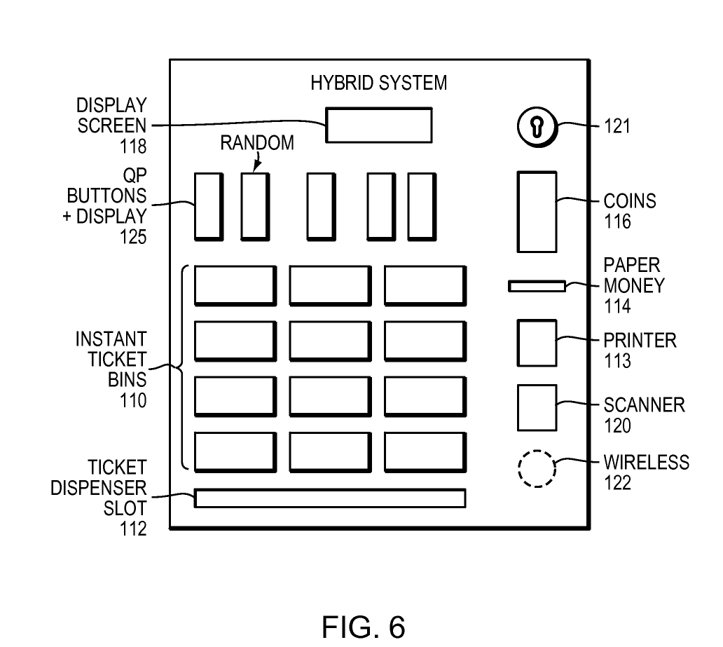

FIG. 6 shows the front panel of a hybrid system, where the side car is incorporated within an ITVM. Here, the Instant Ticket bins 110 are arranged in three columns of four rows. In this embodiment, the bins may be lighted, but may become dark if, for example, the tickets supply is exhausted. Dispensed Instant Tickets are dropped into the slot 112 for retrieval by the player.

In this embodiment, there also is a slot 114 for accepting paper money or other paper chits representing some money value, and there is a mechanism for accepting coins 116. The value of any wager accepted by the hybrid system may be displayed on the screen 118. However, a separate screen may be supplied on some embodiments. There is a key entry 121 for servicing the machine.

Illustratively, there is a row of Quick Pick (QP) push buttons that also display a game and an amount wagered. Here one row of five buttons 125 is shown, but any of the configurations illustrated in the FIGS. 3A-3G drawings may be implemented. In particular, one random button, “$5 RANDOM,” is shown to illustrate the random button shown and discussed with reference to FIG. 3E.

A scanner 120 for a player's card, fob or other such device is provided and operates as described above; and a wireless 122 interface for a cell phone or other hand held device is provided and functions as described above.

Operation of the printer 113, the buttons and displays for the Instant Tickets and the QPs are substantially the same as described above.

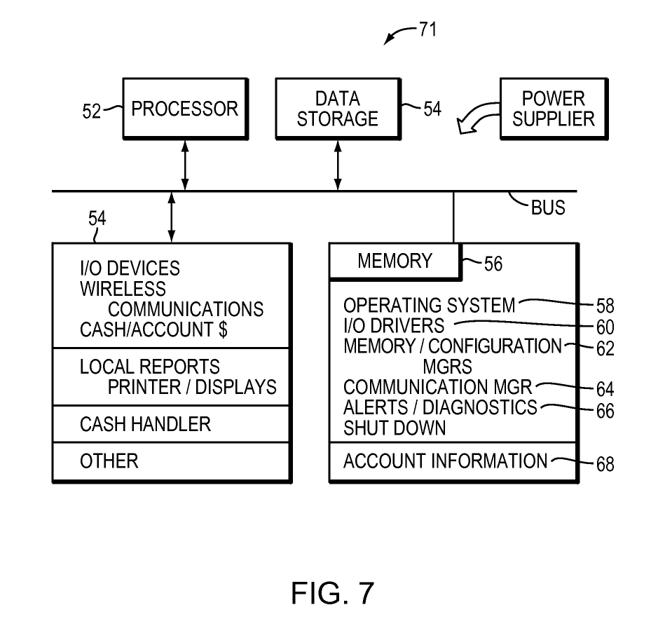

FIG. 7 is a representative diagram of the computer system that may be used to advantage in the side car. A processor 59 may be any of the available microprocessors; data storage 54 may be selected from any available flash, disk or other suitable storage system; and, memory 56 may be any compatible memory system. The memory 56 will contain, at least, an operating system 58; I/O drivers 60; memory configuration managers 62; communications managers 64; and, alerts and diagnostics 66 for servicing, etc., and account information 68.

The communications manager 64 handles information interchange with the retailer and/or the host, but also, if provided, with a player's hand held device.

The I/O devices 60 will include, at least, wireless communications hardware, cash acceptors and account display information, local printer and displays. In addition, there may be additional security hardware (and necessary software in memory 56) to provide security and compliance with the prevailing laws, applicable standards (ISO), and/or test and other specifications, e.g., age verification. Age verification will be found in virtually all of the side car and hybrid embodiments of the present invention. Communications between the side car and the host 73 may be encrypted for security. In some embodiments, a 128 bit public/private encryption code may be used.

Communications may use any format that provides the reliability and security.

The above are illustrative of the type of information and functions that may be exchanged between the host and the side car, and this information and functions are illustrative and not limitations on the present invention.

It should be understood that above-described embodiments are being presented herein as examples and that many variations and alternatives thereof are possible. Accordingly, the present invention should be viewed broadly as being defined only as set forth in the hereinafter appended claims.

What is claimed is:

1. An assembly arranged to be integrated with a lottery ticket vending machine, the lottery ticket vending machine having a first computer system having a first program running the vending machine, the assembly comprising:
a housing with a front panel,
a printer,
displays and buttons arranged on the front panel;
a communication channel; and
a second computer system within the assembly, the second computer system interacting with the printer, displays, buttons, and the communications channel; wherein a player by pressing a single button, executes an on-line quick pick, where the pressing of the single button selects the game and the amount of the wager, wherein the game and the wager are communicated to a host computer system, and wherein the host communicates back to the assembly and authorizes the wager, whereupon the printer prints out a corresponding quick pick ticket.

2. The assembly of claim 1 wherein the pressing of a single button randomly selects a game, and randomly selects numbers associated with that game and prints out a corresponding quick pick ticket.

3. The assembly of claims 1 wherein at least one single button executes an on-line quick pick, where the pressing of the one single button randomly selects a game, and randomly selects one of the instant ticket and dispenses the ticket to the player.

4. The assembly of claim 1 wherein the second computer system comprises a memory and software, wherein the software controls the interfaces with the printer, displays, buttons, and communications channel.

5. The assembly of claim 1 wherein the buttons include physical buttons, touch screen buttons, flat panel buttons, and lighted buttons.

6. The assembly of claim 1 wherein the displays may be integral with the buttons.

7. The assembly of claim 1 wherein the displays and operations of the buttons are programmable.

8. The assembly of claim 1 wherein the exercising of a quick pick comprises pressing two buttons.

9. The assembly of claim 1 wherein the exercising of a quick pick comprises pressing one button more than once.

10. An apparatus comprising a computer system that combines running of the assembly of claim 1 and the lottery ticket vending machine.

11. An apparatus of claim 1 further comprising a scanner that reads a player's card or fob and associates that player's card of fob with an account and favorite games and wagers.

12. An apparatus of claim 1 further comprising a wireless connection to a player's hand held device wherein the player may select wager amounts and games played.

13. A method for integrating an online quick pick vending assembly with a lottery ticket vending machine, the lottery ticket vending machine having a first computer system having a first program running the vending machine, the method comprising the steps of:
attaching the quick pick assembly to the vending machine;
attaching a printer,
attaching displays and buttons to the quick pick assembly;
communication between the quick pick assembly that a player pressed a single button;
exercising a quick pick operation, wherein the player pressing the single button selects a game and an amount of the wager,
communication the game and the wager to a host computer system; and
the host communicating back authorizing the wager, and, in response,
printing out a corresponding quick pick ticket.

14. The method of claim 13 wherein the pressing of the single button executes an on-line quick pick of a randomly selects a game, and randomly selects numbers associated with that game and prints out a corresponding quick pick ticket.

15. The method of claim 12 wherein the steps of claim 9 are controlled by software, wherein the software controls the interfaces including the printer, displays, buttons, and communications channel.

16. The assembly of claim 13 wherein the buttons include physical buttons, touch screen buttons, flat panel buttons, and lighted buttons.

17. The assembly of claim 13 wherein the displays may be integral with the buttons.

18. The assembly of claim 13 wherein the displays and operations of the buttons are programmable.

19. The assembly of claim 13 wherein the exercising of a quick pick comprises pressing two buttons.

20. The assembly of claim 13 wherein the exercising of a quick pick comprises pressing one button more than once.

21. An assembly for dispensing instant tickets, lottery tickets and on-line quick picks, the assembly comprising:
a housing with a front panel;
a printer arranged to output printed material through the front panel;
ticket holding dispensing bins arranged on the front panel, and a slot for collecting selected tickets;
displays and buttons arranged on the front panel;
a scanner arranged on the front panel;
a communication channel to a retailer or a host;
a money accepting mechanism, wherein money is inserted through the front panel;
a computer system within the assembly;
wherein a player by pressing a bin has the ticket dispensed via the slot, and wherein a player by pressing a button selects a game and the amount wagered, wherein the game and the wager are communicated to a host computer system, and wherein the host communicates back to the assembly and authorizes the wager, whereupon the printer prints outs a corresponding quick pick ticket.
